(19) United States
(12) Patent Application Publication
(10) Pub. No.: US 2023/0044834 A1
(43) Pub. Date: Feb. 9, 2023

(54) MICRO-ELECTROMECHANICAL INERTIAL MEASUREMENT UNIT

(71) Applicant: GM GLOBAL TECHNOLOGY OPERATIONS LLC, Detroit, MI (US)

(72) Inventors: Jace A. Mogill, Detroit, MI (US); Steven R. Abram, Ortonville, MI (US); Curtis L. Hay, Washington Township, MI (US)

(73) Assignee: GM GLOBAL TECHNOLOGY OPERATIONS LLC, Detroit, MI (US)

(21) Appl. No.: 17/444,333

(22) Filed: Aug. 3, 2021

(51) Int. Cl. B60W 30/00; G01P 3/00; G01C 19/00; G01P 1/00; G01S 19/01; B60R 16/02

(52) U.S. Cl. CPC B60W 30/00; G01P 3/00; G01C 19/00; G01P 1/00; G01S 19/01; B60R 16/0207; B60W 2520/14; B60W 2520/18; B60W 2520/16; B60W 60/001

(57) ABSTRACT

An inertial measurement unit including a support structure having rectangular cuboid configuration, a first sensor configured to detect a first angular rate wherein the first sensor is affixed to a first side of the support structure, a second sensor configured to detect a second angular rate wherein the second sensor is affixed to a second side of the support structure, a third sensor configured to detect a third angular rate wherein the third sensor is affixed to a third side of the support structure, a processor configured to generate an aggregate angular rate in response to the first angular rate, the second angular rate and the third angular rate, and a vehicle controller configured to control a vehicle in response to the aggregate angular rate.

### INTRODUCTION

The present disclosure relates generally to a system of determining various roll, pitch and yar rate measurements at locations within a motor vehicle. More specifically, aspects of the present disclosure relate to systems, methods and devices for employing a plurality of micro-electromechanical Systems (MEMS) gyroscopes to achieve navigation grade inertial measurement unit (IMU) performance for automated vehicles.

Advanced Driver Assistance Systems (ADAS) and other electronic vehicle systems must accurately detect the location and the motion of a vehicle in order to perform the various tasks to be performed by the vehicle systems. Typically, IMUs are used to continuously detect accelerations and angular rates at various points around the vehicle and a global navigation satellite system (GNSS) is used to detect geo-spatial positioning of the vehicle. This data is then coupled to the ADAS system along with other sensor data, such as Lidar, radar, and camera data such that the environment around the vehicle may be accurately predicted to safely perform the ADAS operation.

The required navigational grade accuracy for IMU in an ADAS system has typically required expensive and complex systems to achieve a bias-stability of 0.01 deg/hour or better. Previously, this level of IMU stability has only available today using expensive Fiber Optic Gyro (FOG) or Ring Laser Gyro (RLG) inertial technologies. It would be desirable to provide a low cost navigational grade IMU for ADAS operations while overcoming the aforementioned problems.

The above information disclosed in this background section is only for enhancement of understanding of the background of the invention and therefore it may contain information that does not form the prior art that is already known in this country to a person of ordinary skill in the art.

### SUMMARY

Disclosed herein are vehicle sensor methods and systems and related control logic for provisioning vehicle systems, methods for making and methods for operating such systems, and motor vehicles equipped with onboard control systems. By way of example, and not limitation, there is presented various embodiments of systems for the accurate determination of vehicle accelerations, and a method for performing angular rate detection in a motor vehicle are disclosed herein.

In accordance with an aspect of the present disclosure, an apparatus including a support structure having rectangular cuboid configuration, a first sensor configured to detect a first angular rate wherein the first sensor is affixed to a first side of the support structure, a second sensor configured to detect a second angular rate wherein the second sensor is affixed to a second side of the support structure, a third sensor configured to detect a third angular rate wherein the third sensor is affixed to a third side of the support structure, a processor configured to generate an aggregate angular rate in response to the first angular rate, the second angular rate and the third angular rate, and a vehicle controller configured to control a vehicle in response to the aggregate angular rate

In accordance with another aspect of the present disclosure, wherein the first side of the support structure, the second side of the support structure and the third side of the support structure form a vertex of the cuboid configuration.

In accordance with another aspect of the present disclosure, wherein the first sensor is oriented along a first axis, the second sensor is oriented along a second axis and the third sensor is oriented along a third axis wherein the first axis, second axis, and third axis pass through a common point and are each pairwise perpendicular.

In accordance with another aspect of the present disclosure, wherein each of the first sensor, the second sensor, and the third sensor include a micro electro-mechanical system.

In accordance with another aspect of the present disclosure, wherein each of the first sensor, the second sensor, and the third sensor include a disk resonator gyroscope.

In accordance with another aspect of the present disclosure, wherein each of the first angular rate, the second angular rate, and the third angular rate include a rotational acceleration.

In accordance with another aspect of the present disclosure, wherein the aggregate angular rate includes at least one of a yaw rate, a roll rate, and a pitch rate.

In accordance with another aspect of the present disclosure, further including an integrated measurement unit processor for estimating a vehicle acceleration in response to the aggregated angular rate and a GNSS data.

In accordance with another aspect of the present disclosure, wherein the processor is affixed to a fourth side of the support structure and is communicatively coupled to the first sensor, the second sensor, and the third sensor by at least one flexible cable.

In accordance with another aspect of the present disclosure, a method including receiving a first angular rate from a first sensor having a first orientation, receiving a second angular rate from a second sensor having a second orientation, receiving a third angular rate from a third sensor having a third orientation, generating an aggregated angular rate in response to the first angular rate, the second angular rate, and the third angular rate, and controlling a vehicle in response to the aggregated angular rate.

In accordance with another aspect of the present disclosure, further including determining a vehicular acceleration in response to the aggregated angular rate and wherein the vehicle is controlled in response to the vehicular acceleration.

In accordance with another aspect of the present disclosure, further including estimating at least one of a vehicle roll, yaw, or pitch in response to the aggregated angular rate.

In accordance with another aspect of the present disclosure, wherein the aggregate angular rate includes at least one of a yaw rate, a roll rate, and a pitch rate.

In accordance with another aspect of the present disclosure, wherein each of the first angular rate, the second angular rate, and the third angular rate include a rotational acceleration

In accordance with another aspect of the present disclosure, wherein the first sensor, the second sensor and the third sensor are each affixed to a support structure having a cuboid configuration.

In accordance with another aspect of the present disclosure, wherein each of the first sensor, the second sensor, and the third sensor include a micro electro-mechanical system.

In accordance with another aspect of the present disclosure, wherein each of the first sensor, the second sensor, and the third sensor includes a disk resonator gyroscope.

In accordance with another aspect of the present disclosure, further including estimating a vehicle acceleration in response to the aggregate angular rate and a GNSS data.

In accordance with another aspect of the present disclosure, a vehicular mirror control system including a support structure having a cuboid configuration with a first side, a second side, and a third side and wherein the first side, second side, and third side form a vertex of the cuboid configuration, a first sensor affixed to the first side of the support structure, the first sensor configured to detect a first angular rate, a second sensor affixed to the second side of the support structure, the second sensor configured to detect a second angular rate, a third sensor affixed to the third side of the support structure, the third sensor configured to detect a third angular rate, a processor communicatively coupled to the first sensor, the second sensor, and the third sensor, the processor being configured to generate an aggregated angular rate in response to the first angular rate, the second angular rate, and the third angular rate, and a vehicle controller configured to perform an advanced driver assistance system operation to control a vehicle in response to the aggregated angular rate.

In accordance with another aspect of the present disclosure, wherein each of the first sensor, the second sensor, and the third sensor include a micro electro-mechanical system and the aggregate angular rate includes at least one of a yaw rate, a roll rate, and a pitch rate.

The above advantage and other advantages and features of the present disclosure will be apparent from the following detailed description of the preferred embodiments when taken in connection with the accompanying drawings.

### BRIEF DESCRIPTION OF THE DRAWINGS

The exemplary embodiments will hereinafter be described in conjunction with the following drawing figures, wherein like numerals denote like elements, and wherein:

FIG. 1 shows a block diagram illustrating a system employing micro-electromechanical inertial measurement unit (IMU) in a motor vehicle according to an exemplary embodiment of the present disclosure;

FIG. 2 shows an illustration of an exemplary sensor for use in an inertial measurement unit (IMU) in a motor vehicle according to an exemplary embodiment of the present disclosure;

FIG. 3 shows a flow chart illustrating an exemplary method for determining an angular rate using a plurality of MEMS sensors according to an exemplary embodiment of the present disclosure;

FIG. 4 shows a block diagram of a system for controlling a motor vehicle in response to an angular rate according to another exemplary embodiment of the present disclosure;

FIG. 5 shows a flow chart illustrating another exemplary method for controlling a motor vehicle in response to an angular rate according to another exemplary embodiment of the present disclosure; and

FIG. 6 shows an illustration of an exemplary sensor arrangement for use in an inertial measurement unit (IMU) in a motor vehicle according to an exemplary embodiment of the present disclosure

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

The present application discloses a system and method of manufacture for a low cost, high performance automotive inter IMU based on state-of-the-art MEMS silicon gyro sensors. The exemplary system may achieve navigation grade IMU performance for automated vehicles with low cost silicon gyro sensors by combining three gyro sensors in an orthogonal X/Y/Z configuration. These sensors will be combined with calibration & control electronics in a small form factor. In some exemplary embodiments, the form factor may be a 20 mm×20 mm×20 mm cube.

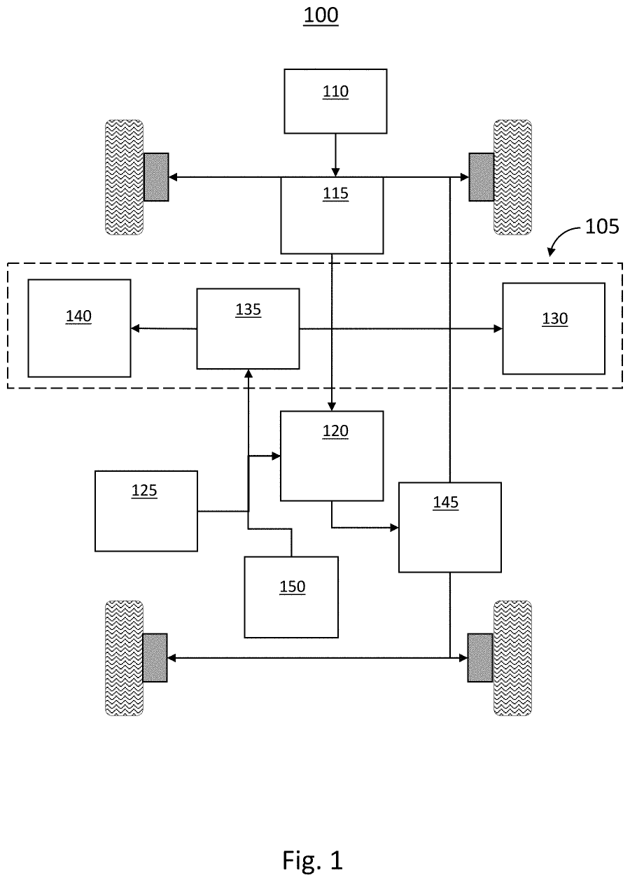

Turning now to FIG. 1, a block diagram illustrating a system 100 employing micro-electromechanical IMU 105 in a motor vehicle according to an exemplary embodiment of the present disclosure is shown. The exemplary system 100 may include an ADAS processor 120, a user interface 125, a vehicle controller 145, a GNSS sensor 150, a camera 110, an image processor 115 and an IMU 105 which may further include a first sensor 140, a second sensor 130 and an IMU processor 135.

The ADAS processor 120 is configured to receive data from the IMU processor 135, the image processor 115, the user interface 125, the GNSS 150, and other vehicle sensor and systems in order to perform an ADAS operation, such as a lane centering operation, adaptive cruise control, fully automated driving, lane change on demand, and other ADAS operations.

The camera 110 may be a front view camera, a rear-view camera or may be one of a plurality of cameras mounted on each side of the vehicle such that all areas around the vehicle are within the field of view of at least one camera. The camera 110 may transmit an image or series of images to the image processor 115 for processing the images and coupling this signal to the ADAS processor 120.

The image processor 115 may be configured to receive images or video data from the one or more cameras 110 and to perform image processing techniques on these images in order to detect objects in the vicinity of the vehicle. Image processing techniques may include edge detection, Histogram of Oriented Gradients (HOG), Region-based Convolutional Neural Networks (R-CNN), Region-based Fully Convolutional Network (R-FCN), Single Shot Detector (SSD), and/or Spatial Pyramid Pooling (SPP-net). The image processor 115 may be configured to generate an object map in response to the detected objects and to couple this object map to the ADAS processor 120 for use during an ADAS operation.

The IMU 105 is a device operative to measure forces on the device such as accelerations, angular rate of change, orientation, etc. These measurements may be made using a plurality of sensors, such as of accelerometers, gyroscopes, and/or magnetometers. Data corresponding to the measured forces may be combined with GNSS data and provided to the ADAS processor 120 or vehicle tracking systems such that the vehicle's current speed, turn rate, heading, inclination and acceleration may be estimated, and dead reckoning operations may be performed. This data may further be combined with the vehicle's wheel speed sensor output and other data from the vehicle controller 145, throttle controller, braking controller, or steering controller.

In some exemplary embodiments, the IMU 105 may include a first sensor 140, a second sensor 130, and an IMU processor 135. The first sensor 140 and the second sensor 130 may be identical sensors where each of the sensors includes multiple angular rate sensors for sensing an angular rate. These angular rates may be provided as roll, pitch and yaw around each of the X, Y, and Z axis. The angular rate data from each of the first sensor 140 and the second sensor 130 may be coupled to the IMU processor 135. The IMU processor 135 may then calculate an aggregate angular rate, an aggregate acceleration, X acceleration, Y acceleration, Z acceleration, and/or pitch, roll and yaw for the vehicle in response to the received angular rate data from each sensor.

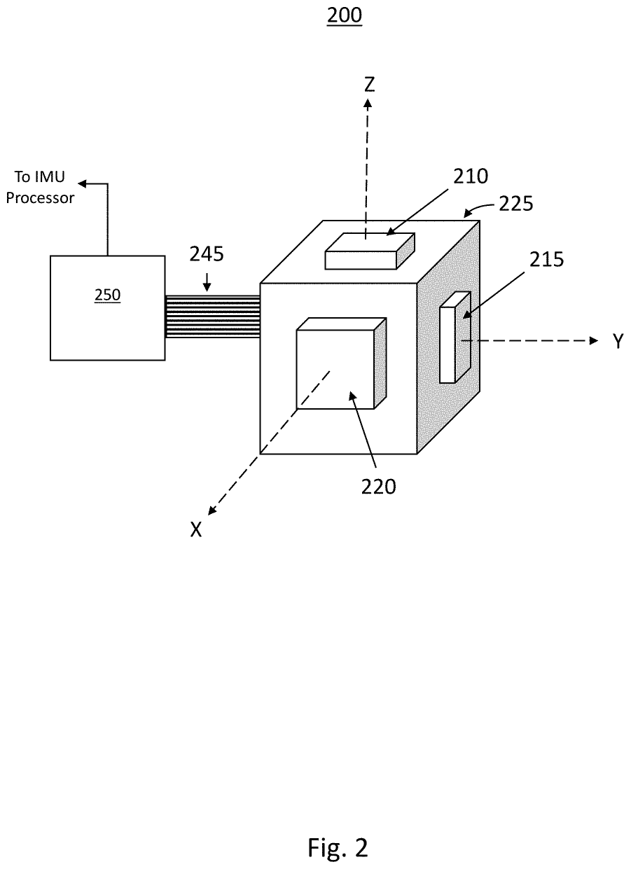

Turning now to FIG. 2, an illustration of an exemplary sensor 200 for use in an IMU in a motor vehicle according to an exemplary embodiment of the present disclosure is shown. The exemplary sensor 200 may include a support structure 225 configured to receive a plurality of MEMS sensors 210, 215, 220, and an application-specific integrated circuit (ASIC) 250 coupled to each of the MEMS sensors 210, 215, 220 by a flexible cable 245. In some exemplary embodiments, the support structure 225 is a cube having six sides wherein three MEMS sensors 210, 215, 220 are positioned in an orthogonal X/Y/Z configuration on three of the sides of the support structures. Each of the MEMS sensors 210, 215, 220 are then electrically coupled to the ASIC by a flexible cable 245. In some embodiments, the MEMS sensors 210, 215, 220 may employ disk resonator gyro (DRG) technology to be used in a vehicle electronic control unit (ECU) for automated vehicle sensing and localization. DRG sensors may have a bias stability of 0.01 deg/hour.

For example, a first MEMS sensor 210 may be affixed to an upper surface of the support structure 225 wherein the upper surface is planar in an X, Y orientation and is orthogonal to a Z axis. The second MEMS sensor 215 may be mounted on a first side surface of the support structure wherein the first side surface is planar in an X, Z orientation and is orthogonal to a Y axis. The third MEMS sensor 220 may be mounted on a second side surface of the support structure wherein the second side surface is planar in a Y, Z orientation and is orthogonal to an X axis. The MEMS sensors 210, 215, 220 may be coupled to an ASIC 250 by at least one flexible cable 245 used to couple data between the MEMS sensors 210, 215, 220 and the ASIC 250. Each of the MEMS sensors 210, 215, 220 may be wire bonded to the flexible cable 245 to the ASIC 250 with wire bonding between ASIC 250 and any module terminal pads. In some embodiments, the first MEMS sensor 210 may be affixed to a printed circuit board and the printed circuit board may be affixed to the upper surface of the support structure 225. Likewise, the second MEMS sensor 215 and the third MEMS sensor 220 may each be affixed to printed circuit boards which are affixed to the first surface and the second surface respectively.

The ASIC 250 may be configured to provide front end interface circuitry for MEMS sensors 210, 215, 220 for external interface (SPI), device diagnostics, and calibration memory. The ASIC 250 may be configured to receive data from each of the MEMS sensors 210, 215, 220. The data may include angular velocities such as roll, pitch and yaw for teach of the MEMS sensors 210, 215, 220. The ASIC 250 is then configured to generate aggregate angular velocities in response to the angular velocities from the MEMS sensors 210, 215, 220. The aggregate angular velocities can be generated using geometric and/or trigonometric operations. In some embodiments, the ASIC 250 may be attached to the support structure such that the sensor 200 has a simplified physical structure. Data from the ASIC 250 may then be coupled to an IMU processor via a cable, bus interface, or the like.

The sensor 200 may be affixed to various locations on a host vehicle. The support structure may include an attachment mechanism, such as a threaded cavity for receiving a threaded bolt. Alternatively, the sensor 200 may be soldered or otherwise affixed to a printed circuit board assembly (PCBA) within an ECU or other host vehicle electronics. The sensor may be housed within a pre-molded ceramic or silicon case with a metal top lid. The sensor housing may further incorporate radio frequency shielding to reduce electromagnetic radiation. For example, a metallic grid may be incorporated within the pre-molded ceramic case or may be applied to a surface of the case to provide a continuous electromagnetic shield. The case may further employ ground points around perimeter of a bottom of the case to provide an electrical ground for the shielding as well as a mechanical support and thermal sink for the sensor 200. The sensor 200 may further be trimmed for temperature offset, scale factor and linearity before final test and shipping using internal electronics and digital interface.

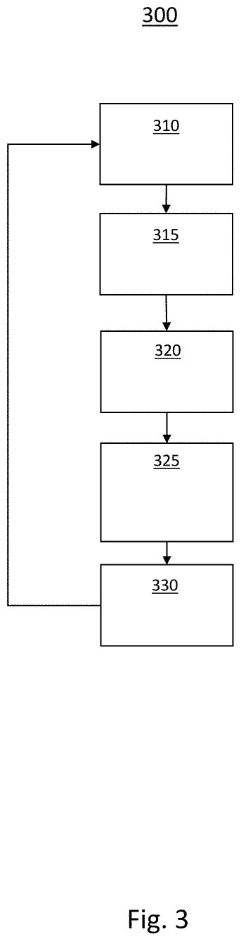

Turning now to FIG. 3, a flow chart illustrating an exemplary method 300 for determining an aggregate angular velocity using a plurality of MEMS sensors according to an exemplary embodiment of the present disclosure is shown. Exemplary method may be performed by an ASIC within an exemplary sensor. In this exemplary embodiment the method is first operative to receive 310 a first angular rate from a first MEMS sensor. The method is operative to receive 315 a second angular rate from a second MEMS sensor. The method next receives 320 a third angular rate from a third MEMS sensor. The first, second and third angular rates may be transmitted between the respective MEMS sensors and the ASIC device via a flexible cable or the like. The ASIC device may be integral to a sensor including the first MEMS sensor, second MEMS sensor, a third MEMS sensor or maybe coupled to the sensor via one or more flexible cables. The first, second, and third angular rates may include angular rates, such as pitch, yaw, and roll and/or angular accelerations for each of the MEMS sensors.

In some exemplary methods, the first MEMS sensor, the second MEMS sensor, and the third MEMS sensor may be collocated with each MEMS sensor being oriented 90 degrees away from each of the other MEMS sensors. For example, the first MEMS sensors may be oriented normal to an X,Y plane, the second MEMS sensor being oriented normal to an X,Z plane and the third MEMS sensor being oriented normal to a Y,Z plane. In the case of the sensor configured around a cubic support structure, the first MEMS sensor may be affixed to a front face of the cubic support structure, the second MEMS sensor may be affixed to a side face of the cubic support structure, and the third MEMS sensor may be affixed to a top face of the cubic support structure.

The method is next configured operative to generate 325 an aggregate angular rate in response to the first angular rate, the second angular rate and third angular rate. The aggregate angular rate may be generated using geometric and trigonometric operations. Calibration and or weighting factors may be applied to one or more of the angular rates before aggregation. The aggregation is performed by the ASIC device. Finally, the method is operative to transmit 330 the aggregate angular rate to an IMU processor. The IMU processor may receive a plurality of aggregated angular rates from various sensors with the vehicle for use by vehicle control systems and the like.

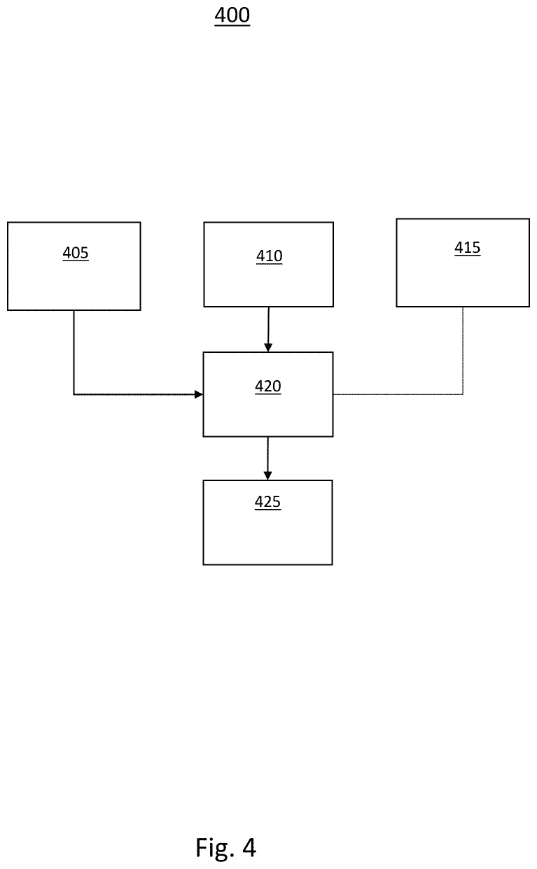

Turning now to FIG. 4, a block diagram of a system 400 for controlling a motor vehicle in response to an aggregated angular rate according to an exemplary embodiment of the present disclosure is shown. A vehicular mirror control system includes a first sensor 405, a second sensor 410, a third sensor 415 and a processor 420 and a vehicle controller 425.

The first sensor 405 is configured to detect a first angular rate at the location of the first sensor 405. The first sensor 405 may be a MEMS angular rate sensor or a disk resonator gyroscope. The first sensor 405 may be configured to detect and report a first angular rate where the first angular rate is an angular velocity, such as a yaw rate, a roll rate, and a pitch rate. Further, the first angular rate may be an angular rate of acceleration. In this example, x, y, and z refer to axis within a three-dimensional cartesian coordinate system.

The first sensor 405 may be rigidly affixed to a portion of a support structure. In one embodiment, the support structure having rectangular cuboid configuration. The support structure may be affixed to a printed circuit board, such as a printed circuit board within a vehicle electronic control unit. Alternatively, the support structure may be affixed to a vehicle chassis or other vehicle component.

Similar to the first sensor 405, the second sensor 410 and the third sensor 415 are also configured to detect and report a second angular rate and a third angular rate at the location of the second sensor 410 and the third sensor 415 respectively. In some embodiments, each of the first angular rate, the second angular rate, and the third angular rate includes a rotational angular rate.

The second sensor 410 and the third sensor 415 may also be rigidly affixed to the support structure in a way such that each of the first sensor 405, second sensor 410 and the third sensor 415 are orientated normal to the plane of the other two sensors. For example, the first sensor 405 may be oriented along the x axis, the second sensor 410 may be oriented along the y axis, and the third sensor may be oriented along the z axis. In this example, the first axis, second axis, and third axis pass through a common point and are each pairwise perpendicular. In some embodiments, the first side of the support structure, the second side of the support structure and the third side of the support structure form a vertex of the cuboid configuration.

The processor 420 may receive the first angular rate value from the first sensor 405, the second angular rate value from the second sensor 410, and the third angular rate value from the third sensor 415. These angular rate values may be transmitted from the sensors to the processor 420 via a flexible cable or the like. The processor 420 is then configured to generate an aggregate angular rate in response to the first angular rate value, the second angular rate value and the third angular rate value. The aggregate angular rate may include one or more of a yaw rate, a roll rate, and a pitch rate. In some embodiments, the processor may be affixed to a fourth side of the support structure and is communicatively coupled to the first sensor, the second sensor, and the third sensor by at least one flexible cable. The flexible cable may be a flexible substrate with electrical traces printed on the flexible substrate.

In some embodiments, the aggregate angular rate may be coupled to an integrated measurement unit processor for estimating a vehicle acceleration in response to the aggregated angular rate and a GNSS data. This vehicle acceleration is then coupled to the vehicle controller for performance of the ADAS algorithm. The vehicle controller is configured to control a vehicle in response to the aggregate angular rate and/or the vehicle acceleration. For example, the vehicle controller may perform an ADAS algorithm and may use the vehicle acceleration as an input to the ADAS algorithm.

In some exemplary embodiments, the system may be an inertial measurement unit including a support structure having a cuboid configuration with a first side, a second side, and a third side and wherein the first side, second side, and third side form a vertex of the cuboid configuration. The exemplary inertial measurement unit further includes a first sensor affixed to the first side of the support structure, the first sensor configured to detect a first angular rate, a second sensor affixed to the second side of the support structure, the second sensor configured to detect a second angular rate. a third sensor affixed to the third side of the support structure, the third sensor configured to detect a third angular rate, a processor communicatively coupled to the first sensor, the second sensor, and the third sensor, the processor being configured to generate an aggregated angular rate in response to the first angular rate, the second angular rate, and the third angular rate, and a vehicle controller configured to perform an advanced driver assistance system operation to control a vehicle in response to the aggregated angular rate. In some embodiments, each of the first sensor, the second sensor, and the third sensor may include a micro electro-mechanical system and the aggregate angular rate may include a yaw rate, a roll rate, and a pitch rate.

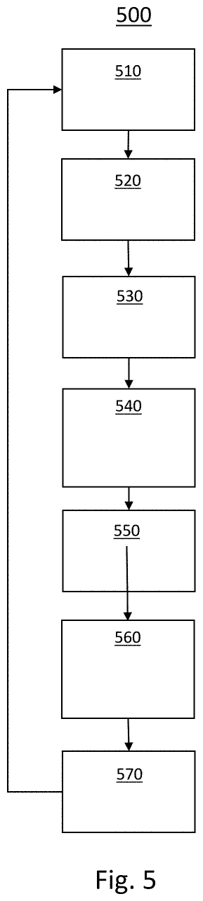

Turning now to FIG. 5, a flow chart illustrating another exemplary method 500 for controlling a motor vehicle in response to an aggregated angular rate according to an exemplary embodiment of the present disclosure is shown. The method is first operative for receiving 510 a first angular rate from a first sensor having a first orientation. The first sensor may be affixed to a support structure and located at a position within the motor vehicle. The first angular rate detected by the first sensor may include at least one of a yaw rate, a roll rate, and a pitch rate.

The method is next configured for receiving 520 a second angular rate from a second sensor having a second orientation. The second sensor may also be affixed to the support structure such that the second orientation is not equal to the first orientation. In some exemplary embodiments, the second orientation is orthogonal to the first orientation. For example, the first orientation may be parallel to a centerline of the vehicle where the centerline runs from the front to the back of the vehicle. The second orientation would then be perpendicular to the centerline of the vehicle.

The method is next configured for receiving 530 a third angular rate from a third sensor having a third orientation. In some exemplary embodiments, the third orientation is orthogonal to both the first orientation and the second orientation. The third orientation may be 90 degrees from the centerline of the vehicle and 90 degrees from the orientation which is perpendicular to the centerline. For example, the third orientation may be vertical, the second orientation may be lateral and the first orientation may be longitudinal. In some embodiments, each of the first angular rate, the second angular rate, and the third angular rate includes a rotational acceleration. Each of the first angular rate, second angular rate, and third angular rates may include at least one of an a roll rate, a yaw rate and a pitch rate.

In some embodiments, the support structure may have a cuboid configuration and wherein the first sensor, the second sensor and the third sensor are each affixed to a different side support structure. For example, the first sensor may be mounted to a front face of the cuboid support structure, the second sensor may be mounted to a side face of the cuboid support structure, and the third sensor may be mounted to a top face of the cuboid support structure. In this example, each of the sensors has a normal orientation to the plane of orientation of the other two sensors.

The method next generates 540 an aggregated angular rate in response to the first angular rate, the second angular rate, and the third angular rate, wherein the aggregate angular rate includes at least one of a yaw rate, a roll rate, and a pitch rate. Each of the first angular rate, the second angular rate, and the third angular rate may be weighted before being used to compute the aggregated angular rate. The aggregated angular rate may then be transmitted 550 to a vehicle controller and/or an IMU processor.

The method is next operative to estimate 560 a vehicular acceleration in response to the aggregated angular rate and additional aggregated angular rates from other sensors in the vehicle. For example, a system performing the exemplary method may include multiple support structures located at different locations within a vehicle. Each of these exemplary support structures may include multiple sensors as described previously. An ASIC coupled to each of the groups of multiple sensors may then determine an aggregate angular rate for that location within the vehicle and transmit this aggregated angular rate to an IMU processor. The IMU processor may then determine a vehicle acceleration in response to the multiple aggregated accelerations.

The method may then be configured for generating 560 a vehicle acceleration in response to the aggregate angular rate and a GNSS data. The GNSS data may include location and altitude data and may be received from a GNSS sensor, such as a GPS receiver or the like. The location data and the vehicle acceleration data may then be coupled to a vehicle controller and used for controlling 570 a vehicle in response to an ADAS algorithm or the like.

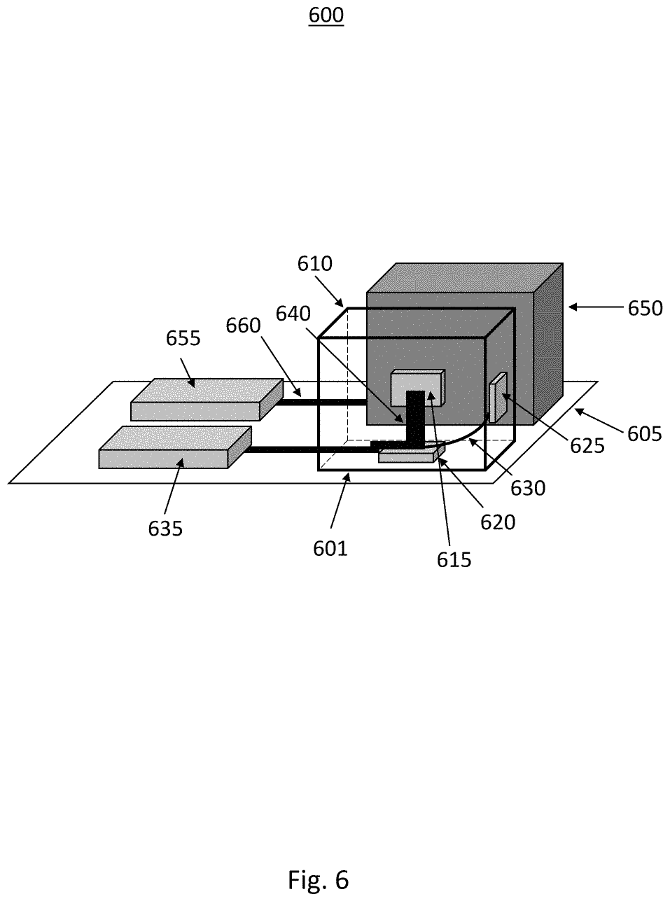

Turning now to FIG. 6, another exemplary sensor arrangement 600 for use in an IMU in a motor vehicle according to an exemplary embodiment of the present disclosure is shown. An exemplary first sensor 601 may include a first disk resonator gyro 615, a second disk resonator gyro 620 and a third disk resonator gyro 625 mounted inside a cuboid enclosure 610. In some exemplary embodiments, the enclosure 610 may be fabricated from a ceramic material to provide thermal stability and more closely match the thermal performance for the disk resonator gyros 615, 620, 625. In addition, the enclosure 610 may be coated on the inside, outside or have a metallic meshed formed inside the ceramic material to provide electromagnetic shielding for the interior of the enclosure 610. The metallic coating or metallic mesh may be electrically coupled to a grounded portion of a printed circuit board 605. The enclosure 610 may include a detachable lid, also covered with the metallic coating and being electrically coupled to the sides of the enclosure 610. Alternatively, the enclosure 610 may be open on the bottom and electrically coupled to a ground plane or mesh embedded into the printed circuit board 605 thereby creating a fully metallic enclosure for reduction of emissions and reception of electromagnetic radiation through the enclosure 610. Large metallic tabs may be employed on the enclosure 610 for secure connection to the printed circuit board 605 in order to provide a rigid and reliable physical connection, low resistance electrical coupling, thermal conduction and electromagnetic shielding.

The first disk resonator gyro 615, the second disk resonator gyro 620 and the third disk resonator gyro 625 may be communicatively coupled to and ASIC 635 by one or more cables or flexible circuit boards 625, 630, 640. Electrical conductors may be formed on the flexible circuit boards 625, 630, 640 and each of the disk resonator gyros 615, 620, 625 may be wire bonded to the electrical conductors. Alternatively, the disk resonator gyros 625, 630, 640 may be coupled to the flexible circuit boards 625, 630, 640 via a ball grid array surface mount configuration.

Each of the disk resonator gyros 615, 620, 625 are mounted orthogonally to each other on different sides of the enclosure 610. For example, the first disk resonator gyro 615 may be mounted inside a back side of the enclosure 610, the second disk resonator gyro 620 may be mounted inside a bottom side of the enclosure 610 and the third disk resonator gyro 625 may be mounted inside a side of the enclosure 610. Each of the disk resonator gyros 615, 620, 625 is configured to detect angular rates, such as pitch, yaw and roll. The outputs of each of the disk resonator gyros 615, 620, 625 is then communicatively coupled to the ASIC 635. The data transmitted from each of the disk resonator gyros 615, 620, 625 may be an analog data value coupled to the ASIC 635. The ASIC 635 may be further configured to transform the data in a digital format for coupling to an IMU processor or vehicle controller. The data may be transmitted according via a serial peripheral interface (SPI) wherein the SPI frame of data contains 3 angular rate values along with an invalid bit for each of those rate values. The ASIC 635 may further provide provides feedback and calibrations by performing algorithms to calibrate the output of the sensor 601 in response to temperature, scaling, bias drift resulting from temperature. A temperature sensor may be built into the ASIC 635 or could be external with the temperature data communicatively coupled to the ASIC 635.

The exemplary sensor system 600 may further include a second sensor 650, a second ASIC 655 and a second communicative coupling 660 for communicating data between the second sensor 650 and the second ASIC. The second sensor 650 and second ASIC 655 may be identical to the first sensor 601 and the ASIC 635 and may be used for redundancy to in the case of sensor failure. In addition, the outputs from the first sensor 601 and the second sensor 650 and the ASIC 635 and the second ASIC 655 may be compared for calibration purposes and fault detection.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a support structure having rectangular cuboid configuration;
a first sensor configured to detect a first angular rate wherein the first sensor is affixed to a first side of the support structure;
a second sensor configured to detect a second angular rate wherein the second sensor is affixed to a second side of the support structure;
a third sensor configured to detect a third angular rate wherein the third sensor is affixed to a third side of the support structure;
a processor configured to generate an aggregate angular rate in response to the first angular rate, the second angular rate and the third angular rate; and
a vehicle controller configured to control a vehicle in response to the aggregate angular rate.

2. The apparatus of claim 1, wherein the first side of the support structure, the second side of the support structure and the third side of the support structure form a vertex of the cuboid configuration.

3. The apparatus of claim 1, wherein the first sensor is oriented along a first axis, the second sensor is oriented along a second axis and the third sensor is oriented along a third axis wherein the first axis, second axis, and third axis pass through a common point and are each pairwise perpendicular.

4. The apparatus of claim 1, wherein each of the first sensor, the second sensor, and the third sensor include a micro electro-mechanical system.

5. The apparatus of claim 1, wherein each of the first sensor, the second sensor, and the third sensor include a disk resonator gyroscope.

6. The apparatus of claim 1 wherein each of the first angular rate, the second angular rate, and the third angular rate include a rotational acceleration.

7. The apparatus of claim 1 wherein the aggregate angular rate includes at least one of a yaw rate, a roll rate, and a pitch rate.

8. The apparatus of claim 1 further including an integrated measurement unit processor for estimating a vehicle acceleration in response to the aggregated angular rate and a GNSS data.

9. The apparatus of claim 1 wherein the processor is affixed to a fourth side of the support structure and is communicatively coupled to the first sensor, the second sensor, and the third sensor by at least one flexible cable.

10. A method comprising:
receiving a first angular rate from a first sensor having a first orientation;
receiving a second angular rate from a second sensor having a second orientation;
receiving a third angular rate from a third sensor having a third orientation;
generating an aggregated angular rate in response to the first angular rate, the second angular rate, and the third angular rate; and
controlling a vehicle in response to the aggregated angular rate.

11. The method of claim 10, further including determining a vehicular acceleration in response to the aggregated angular rate and wherein the vehicle is controlled in response to the vehicular acceleration.

12. The method of claim 10, further including estimating at least one of a vehicle roll, yaw, or pitch in response to the aggregated angular rate.

13. The method of claim 10, wherein the aggregate angular rate includes at least one of a yaw rate, a roll rate, and a pitch rate.

14. The method of claim 10, wherein each of the first angular rate, the second angular rate, and the third angular rate include a rotational acceleration

15. The method of claim 10, wherein the first sensor, the second sensor and the third sensor are each affixed to a support structure having a cuboid configuration.

16. The method of claim 10, wherein each of the first sensor, the second sensor, and the third sensor include a micro electro-mechanical system.

17. The method of claim 10, wherein each of the first sensor, the second sensor, and the third sensor includes a disk resonator gyroscope.

18. The method of claim 10, further including estimating a vehicle acceleration in response to the aggregate angular rate and a GNSS data.

19. A vehicular control system comprising:
a support structure having a cuboid configuration with a first side, a second side, and a third side and wherein the first side, second side, and third side form a vertex of the cuboid configuration;
a first sensor affixed to the first side of the support structure, the first sensor configured to detect a first angular rate;
a second sensor affixed to the second side of the support structure, the second sensor configured to detect a second angular rate;
a third sensor affixed to the third side of the support structure, the third sensor configured to detect a third angular rate;
a processor communicatively coupled to the first sensor, the second sensor, and the third sensor, the processor being configured to generate an aggregated angular rate in response to the first angular rate, the second angular rate, and the third angular rate; and
a vehicle controller configured to perform an advanced driver assistance system operation to control a vehicle in response to the aggregated angular rate.

20. The vehicular control system of claim 19 wherein each of the first sensor, the second sensor, and the third sensor include a micro electro-mechanical system and the aggregate angular rate includes at least one of a yaw rate, a roll rate, and a pitch rate.
